(19) United States
(12) Patent Application Publication
(10) Pub. No.: US 2026/0099237 A1
(43) Pub. Date: Apr. 9, 2026

(54) TOUCH ICON MODULE

(71) Applicant: Primax Electronics Ltd., Taipei (TW)

(72) Inventors: Jia-Hung Lin, Taipei (TW); Hui-Ling Lin, Taipei (TW); Yu-Zeng Yang, Taipei (TW)

(21) Appl. No.: 18/948,282

(22) Filed: Nov. 14, 2024

(30) Foreign Application Priority Data
Oct. 8, 2024 (TW) 113138239

(51) Int. Cl. G06F 3/04817; G06F 3/0354; G06F 3/04886

(52) U.S. Cl. CPC G06F 3/04817; G06F 3/03547; G06F 3/04886

(57) ABSTRACT

A touch icon module is electrically connected with an electronic device to control the electronic device. The touch icon module includes a touch plate, a main icon and a plurality of auxiliary icons. The touch plate has a main area and a plurality of auxiliary areas. The auxiliary areas are located beside the main area. The main icon on the touch plate corresponds to the main area. The plurality of auxiliary icons correspond to the plurality of auxiliary areas. Each auxiliary icon corresponds to one auxiliary area. After the main icon is touched, the main area generates a first touch signal to control the plurality of auxiliary icons to be displayed in the plurality of auxiliary areas. After one of the auxiliary icons is touched, one of the auxiliary areas corresponding to the touched auxiliary icon generates a second touch signal to control the electronic device.

### FIELD OF THE INVENTION

The present invention relates to a touch input device, and more particularly to a touch icon module.

### BACKGROUND OF THE INVENTION

Generally, a conventional touch module mainly provides a user with a touch surface to trigger a control instruction to control an electronic device. For example, the touch module has been widely used in notebook computers. Conventionally, there is no icon on the touch surface of the touch module. If a shortcut function key corresponding to a specified function is required to be set, a physical key or a touch key area should be additionally provided. Nowadays, for installing the shortcut function keys, a single shortcut function corresponding to a single icon is located in a single key area. For example, the volume adjustment function requires three key areas, including a volume up key, a volume down key and a mute key. Even if many shortcut function items belong to the same type, a plurality of shortcut function keys are needed according to different effects. If there are too many shortcut function items, some shortcut function items need to be discarded to reduce the occupied key area when designing the touch surface. Furthermore, the user may be confused by the icons because of too many shortcut function keys and cannot quickly use the icons to find the function he (she) wants to activate.

### SUMMARY OF THE INVENTION

For solving the drawbacks of the conventional technologies, the present invention provides a touch icon module. The touch icon module can be electrically connected to an electronic device to control the electronic device. The touch surface of the touch icon module has an operation area. The operation area has a main area and a plurality of auxiliary areas. The plurality of auxiliary areas and the main area are closely adjacent to each other. The main icon and the plurality of auxiliary icons are included in the operation area of the touch surface. The main icon corresponds to the main area. The plurality of auxiliary icons correspond to the plurality of auxiliary icons. The main area with the main icon corresponds to a main function. The plurality of auxiliary areas with the plurality of auxiliary icons correspond to a plurality of auxiliary functions or a plurality of function statuses. The plurality of auxiliary icons need to be linked with the main icon for performing associated triggering and controlling operation. Through the user’s touch control of the main icon and the auxiliary icon, the main area and the auxiliary areas are triggered to implement the control switching and adjustment of the corresponding functions. In case that the main icon is not changed and the main function is maintained, the auxiliary icon can be used to trigger the on/off statuses of the auxiliary functions or change the function statuses. In a single touch icon area with a limited range, various function switching and adjustment effects will be given. Furthermore, the technologies of present invention can significantly reduce the number and range of function key areas in order to avoid space waste and reduce design cost. The user can find the function key to be activated more quickly, activate the function item quickly, and confirm whether the function is successfully activated

In accordance with an aspect of the present invention, a touch icon module is electrically connected with an electronic device to control the electronic device. The touch icon module includes a touch plate, a main icon and a plurality of auxiliary icons. The touch plate includes an operation area. The operation area has a main area and a plurality of auxiliary areas. The plurality of auxiliary areas are located beside an edge of the main area. The main icon is included in the operation area. The main icon corresponds to the main area. The plurality of auxiliary icons are included in the operation area. The plurality of auxiliary icons correspond to the plurality of auxiliary areas. Each auxiliary icon corresponds to one of the plurality of auxiliary areas. After the main icon is touched, the main area generates a first touch signal to control the plurality of auxiliary icons to be displayed in the plurality of auxiliary areas. After one of the auxiliary icons is touched, one of the auxiliary areas corresponding to the touched auxiliary icon generates a second touch signal to control the electronic device.

In an embodiment, the plurality of auxiliary areas and the main area are located beside each other, the plurality of auxiliary icons are located beside the main icon, and the plurality auxiliary icons are located beside each other.

In an embodiment, the main icon prompts activation statuses of the plurality of auxiliary icons, and the plurality of auxiliary icons prompt a function control status of the electronic device.

In an embodiment, the touch icon module further comprises a function instruction table, and the function instruction table contains a plurality of function instructions corresponding to a plurality of functions of the electronic device. Each of the function instructions corresponds to one of the plurality of functions.

In an embodiment, the main area of the operation area corresponds to the function instruction table, the plurality of auxiliary areas of the operation area correspond to the plurality of function instructions, and each of the auxiliary areas corresponds to one of the plurality of function instructions.

In an embodiment, after the main icon is touched, the main area generates the first touch signal to control the function instruction table, and the plurality of auxiliary icons are displayed in the plurality of auxiliary areas according to the first touch signal.

In an embodiment, after one of the plurality of auxiliary icons is touched, the auxiliary area corresponding to the touched auxiliary icon generates a second touch signal, the function instruction corresponding to the auxiliary area is controlled according to the second touch signal, and the corresponding function of the electronic device is controlled according to the function instruction.

In an embodiment, the touch plate includes a main light source and a plurality of auxiliary light sources. The main light source corresponds to the main area and the main icon. The plurality of auxiliary light sources correspond to the plurality of auxiliary areas and the plurality of auxiliary icons.

In an embodiment, the main icon is continuously illuminated by the main light source, so that the main icon is continuously displayed on the touch plate. When the main icon is touched and the main area generates the first touch signal, the plurality of auxiliary light sources are controlled to illuminate the plurality of auxiliary icons according to the first touch signal, so that the plurality of auxiliary icons are displayed in the plurality of auxiliary areas.

In an embodiment, when one of the plurality of auxiliary icons is touched and the corresponding auxiliary area generates the second touch signal, the plurality of auxiliary light sources are controlled according to the second touch signal.

In accordance with another aspect of the present invention, a touch icon module is electrically connected with an electronic device to control the electronic device. The touch icon module includes a touch plate, a main icon and a plurality of auxiliary icons. The touch plate includes an operation area. The operation area has a main area and a plurality of auxiliary areas. The plurality of auxiliary areas are adjacent to the main area and located beside an edge of the main area. The main icon is included in the operation area. The main icon corresponds to the main area. The plurality of auxiliary icons are included in the operation area. The plurality of auxiliary icons correspond to the plurality of auxiliary areas. Each auxiliary icon corresponds to one of the plurality of auxiliary areas. After the main icon is touched, the main area generates a first touch signal to activate the function of the electronic device. After one of the auxiliary icons is touched, one of the auxiliary areas corresponding to the touched auxiliary icon generates a second touch signal to adjust the function of the electronic device.

In an embodiment, the main icon prompts an activation status of the function, and the plurality of auxiliary icons prompt an adjustment status of the function of the electronic device. An area of each of the plurality of auxiliary icons is smaller than an area of the main icon.

In an embodiment, the touch icon module further provides a function instruction and a plurality of function adjustment instructions, and the function of the electronic device has a plurality of function statuses. The function instruction corresponds to the function of the electronic device. The plurality of function adjustment instructions correspond to the plurality of function statuses of the function. Each of the function adjustment instructions corresponds to one of the plurality of function statuses.

In an embodiment, the main area of the operation area corresponds to the function instruction, the plurality of auxiliary areas correspond to the plurality of function adjustment instructions, and each of the auxiliary areas corresponds to one of the plurality of function adjustment instructions.

In an embodiment, after the main icon is touched, the main area generates the first touch signal to trigger the function instruction of the electronic device and activate or inactivate the function of the electronic device.

In an embodiment, after one of the plurality of auxiliary icons is touched, the auxiliary area corresponding to the touched auxiliary icon generates the second touch signal to trigger the function adjustment instruction corresponding to the auxiliary area. The corresponding function status of the electronic device is adjusted according to the function adjustment instruction.

In an embodiment, the touch plate includes a main light source and a plurality of auxiliary light sources. The main light source corresponds to the main area and the main icon. The plurality of auxiliary light sources correspond to the plurality of auxiliary areas and the plurality of auxiliary icons. Each of the auxiliary light sources corresponds to one of the plurality of auxiliary areas and one of the plurality of auxiliary icons.

In an embodiment, when the main area generates the first touch signal, the main light source is controlled to illuminate the main icon, and the plurality of auxiliary light sources are controlled to illuminate the plurality of auxiliary icons. When the plurality of auxiliary areas generate the second control signal, the plurality of auxiliary light sources are controlled to illuminate the plurality of auxiliary icons according to the second touch signal, and the main light source is controlled to illuminate the main icon according to the second touch signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a computing device with a touch icon module according to a first embodiment of the present invention;

FIG. 2 is a schematic exploded view illustrating the touch icon module according to the first embodiment of the present invention;

FIG. 3A is a planar view illustrating the touch icon module in a general status mode;

FIG. 3B is a planar view illustrating the touch icon module in a shortcut function trigger mode;

FIG. 4 is a schematic functional block diagram illustrating a signal processing process of the touch icon module according to the first embodiment of the present invention;

FIG. 5A schematically illustrates the image shown on the touch plate of the touch icon module according to the first embodiment of the present invention when the touch icon module is in the general status mode;

FIG. 5B schematically illustrates the image shown on the touch plate of the touch icon module according to the first embodiment of the present invention when the touch icon module is switched to the shortcut function trigger mode;

FIG. 5C schematically illustrates the image shown on the touch plate of the touch icon module according to the first embodiment of the present invention when an auxiliary icon is touched;

FIG. 6 is a schematic perspective view illustrating a computing device with a touch icon module according to a second embodiment of the present invention;

FIG. 7 is a schematic exploded view illustrating the touch icon module according to the second embodiment of the present invention;

FIG. 8 is a planar view illustrating the touch icon module in a shortcut function trigger mode;

FIG. 9 is a schematic functional block diagram illustrating a signal processing process of the touch icon module according to the second embodiment of the present invention

FIG. 10A schematically illustrates the image shown on the touch plate of the touch icon module according to the first embodiment of the present invention when the touch icon module is in the general status mode;

FIG. 10B schematically illustrates the image shown on the touch plate of the touch icon module according to the second embodiment of the present invention when a function of the electronic device is activated;

FIG. 10C schematically illustrates the image shown on the touch plate of the touch icon module according to the second embodiment of the present invention when an auxiliary icon is touched; and

FIG. 10D schematically illustrates the image shown on the touch plate of the touch icon module according to the second embodiment of the present invention when another auxiliary icon is touched.

### DETAILED DESCRIPTION OF THE PREFERRED EMBODIMENT

The present invention will now be described more specifically with reference to the following embodiments and accompanying drawings.

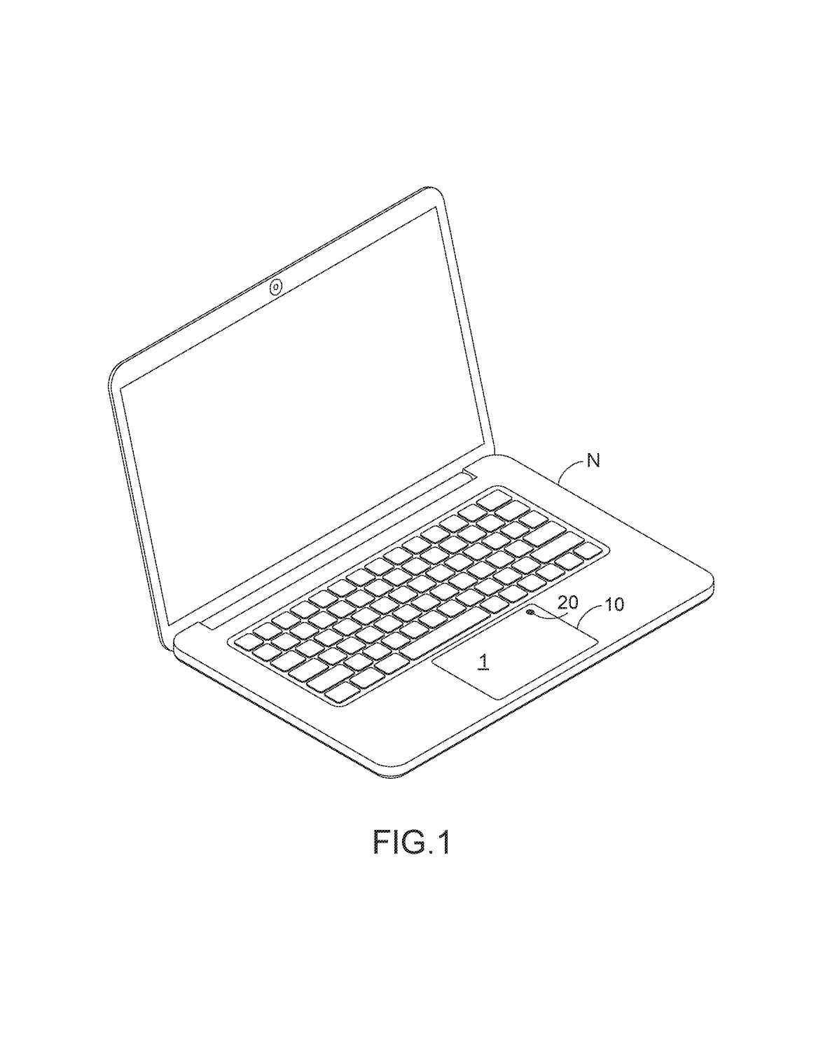

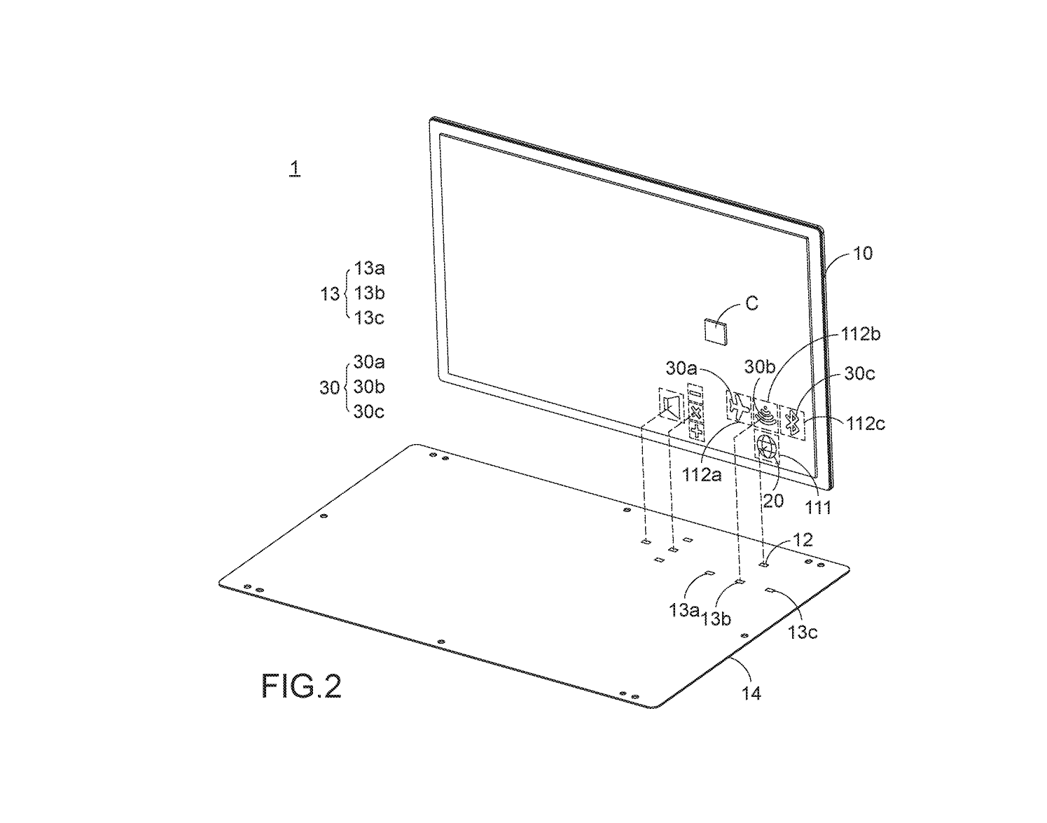

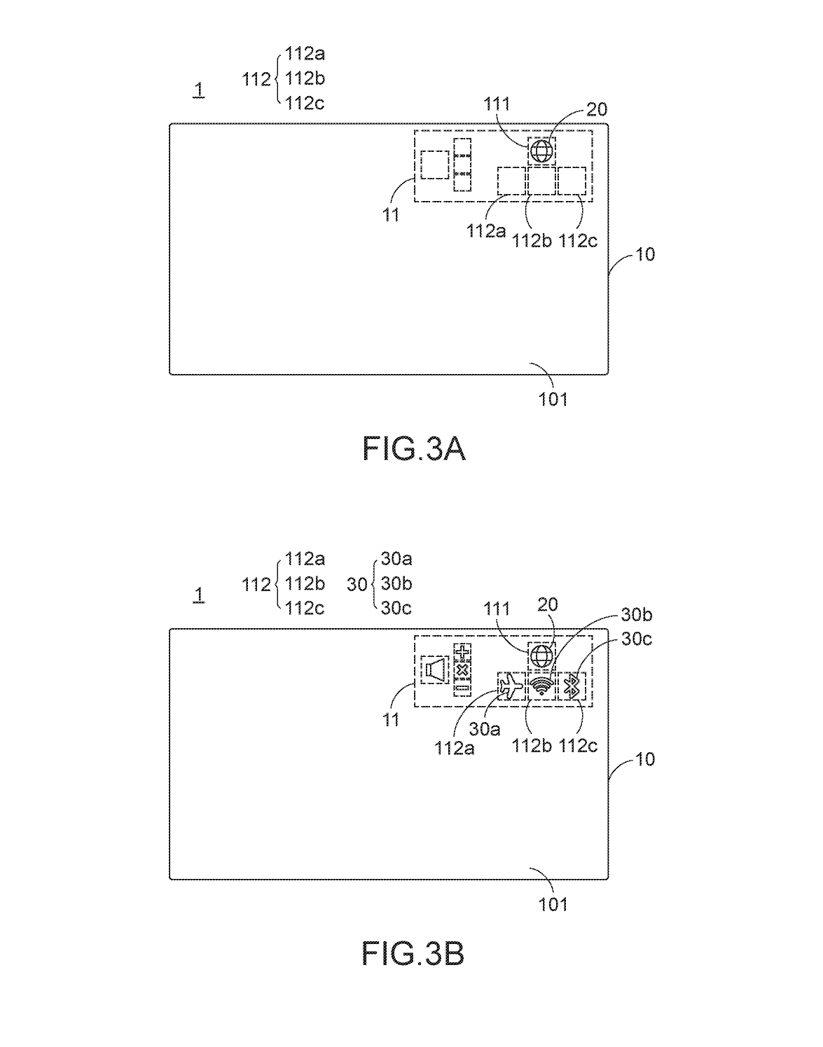

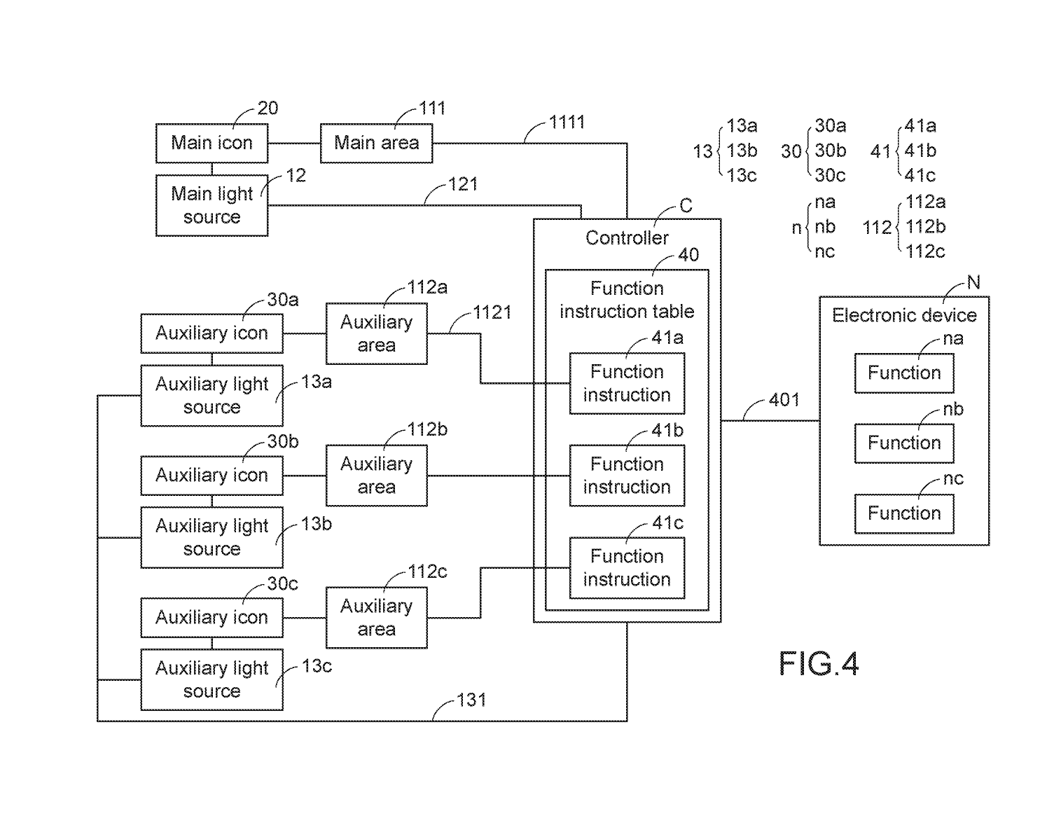

The present invention provides a touch icon module. FIG. 1 is a schematic perspective view illustrating a computing device with a touch icon module according to a first embodiment of the present invention. FIG. 2 is a schematic exploded view illustrating the touch icon module according to the first embodiment of the present invention. FIG. 3A is a planar view illustrating the touch icon module in a general status mode. FIG. 3B is a planar view illustrating the touch icon module in a shortcut function trigger mode. FIG. 4 is a schematic functional block diagram illustrating a signal processing process of the touch icon module according to the first embodiment of the present invention.

The touch icon module 1 is electrically connected with an electronic device N. The electronic device N has a plurality of functions n. The plurality of functions n of the electronic device N can be controlled through the touch icon module 1.

In this embodiment, the touch icon module 1 includes a touch plate 10, a main icon 20 and a plurality of auxiliary icons 30. The touch icon module 1 can be selectively operated in one of two operation modes. These two operation modes include a general status mode and a shortcut function trigger mode.

In the general status mode, the plurality of auxiliary icons 30 are not displayed on the touch plate 10, and the touch plate 10 only provides ordinary touching and sliding pointer function. After the main icon 20 is touched, the operation mode is switched to the shortcut function trigger mode. Since the main icon 20 is triggered, the plurality of auxiliary icons 30 are displayed on the touch plate 10.

In the shortcut function trigger mode, the touch plate 10 is divided into an operation area 11 and a general touch area 101. That is, the touch plate 10 is divided into two areas. Meanwhile, the main icon 20 and the plurality of auxiliary icons 30 are displayed on the operation area 11 to achieve the shortcut function trigger purpose, and the main icon 20 and the plurality of auxiliary icons 30 are not displayed on the general touch area 101 to maintain the ordinary touching and sliding pointer function. Since the main icon 20 and the plurality of auxiliary icons 30 are displayed on the operation area 11, the user can directly touch and click the main icon 20 and the plurality of auxiliary icons 30 to perform shortcut startup operations or functionality operations for the plurality of functions n of the electronic device N. In addition, since the general touch area 101 maintains the ordinary touching and sliding pointer function, the user can perform other non-shortcut function operations.

As mentioned above, the touch icon module 1 includes the touch plate 10, the main icon 20 and the plurality of auxiliary icons 30. The touch plate 10 is provided with the operation area 11, the general touch area 101, a main light source 12, a plurality of auxiliary light sources 13 and a circuit layer 14. The general touch area 101 and the operation area 11 are located beside each other. The general touch area 101 can provide the ordinary touching and sliding pointer function only. The operation area 11 includes a main area 111 and a plurality of auxiliary areas 112. The plurality of auxiliary areas 112 are located near the edge of the main area 111. That is, the plurality of auxiliary areas 112 are located beside the main area 111. The plurality of auxiliary icons 30 are located beside the main icon 20. In addition, the plurality of auxiliary icons 30 are located beside each other. The circuit layer 14 is formed in the touch plate 10. The main light source 12 and the plurality of auxiliary light sources 13 are installed on the circuit layer 14. The main icon 20 is included in the operation area 11. In addition, the main icon 20 corresponds to the main area 111. The plurality of auxiliary icons 30 are included in the operation area 11. In addition, the plurality of auxiliary icons 30 correspond to the plurality of auxiliary areas 112, respectively. That is, each auxiliary icon 30 corresponds to one of the auxiliary areas 112. The main light source 12 corresponds to the main area 111 and the main icon 20. The auxiliary light sources 13 correspond to the plurality of auxiliary areas 112 and the plurality of auxiliary icons 30. Preferably, each auxiliary light source 13 corresponds to one of the auxiliary areas 112 and one of the auxiliary icons 30.

In the general status mode of the touch icon module 1, only the main icon 20 is continuously displayed on the touch plate 10. After the main icon 20 is touched, the operation mode is switched to the shortcut function trigger mode. When the main icon 20 is touched, the main area 111 generates a first touch signal 1111. In response to the first touch signal 1111, the plurality of auxiliary icons 30 are controlled to be displayed on the plurality of auxiliary areas 112. Subsequently, when one auxiliary icon 30 of the plurality of auxiliary icons 30 is touched, the auxiliary area 112 corresponding to the touched auxiliary icon 30 generates a second touch signal 1121 to control the electronic device N. Furthermore, the main icon 20 can be used to prompt the activation status of plurality of auxiliary icons 30. The status change of the main icon 20, e.g., the lighting status change or the icon color change, can be used to prompt the user that the plurality of auxiliary icons 30 have been displayed and the shortcut function trigger mode has been activated. The plurality of auxiliary icons 30 are used to prompt the control status of the function n of the electronic device N. The status changes of the plurality of auxiliary icons 30, e.g., the lighting status changes or icon color changes, can be used to prompt the user whether the function n of the electronic device N has been successfully activated and controlled.

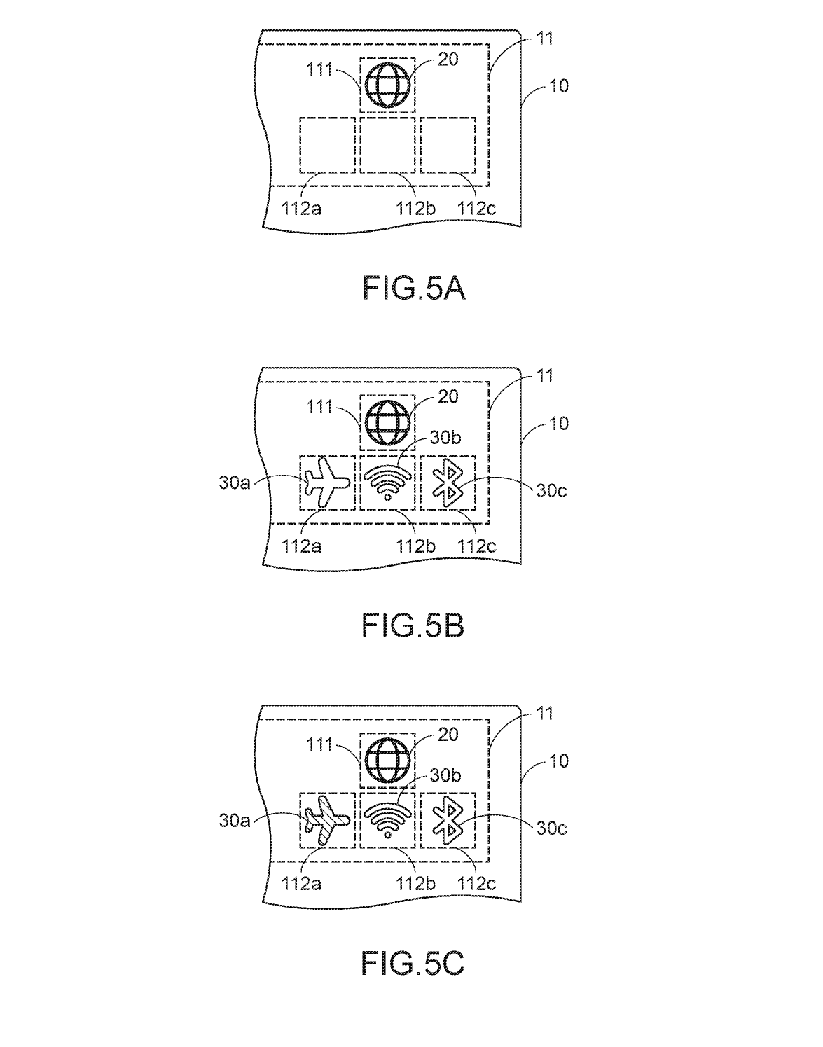

Hereinafter, the icon triggering mechanism and the control method for the touch icon module of the first embodiment will be illustrated with reference to FIG. 3A, FIG. 3B, FIG. 4, FIG. 5A, FIG. 5B and FIG. 5C. FIG. 5A schematically illustrates the image shown on the touch plate of the touch icon module according to the first embodiment of the present invention when the touch icon module is in the general status mode. FIG. 5B schematically illustrates the image shown on the touch plate of the touch icon module according to the first embodiment of the present invention when the touch icon module is switched to the shortcut function trigger mode. FIG. 5C schematically illustrates the image shown on the touch plate of the touch icon module according to the first embodiment of the present invention when an auxiliary icon is touched.

For illustration, a plurality of function instructions 41 are respectively labeled as function instructions 41a, 41b and 41c, the plurality of auxiliary areas 112 are respectively labeled as auxiliary areas 112a, 112b and 112c, the plurality of auxiliary icons 30 are respectively labeled as auxiliary icons 30a, 30b and 30c, and the plurality of auxiliary light sources 13 are respectively labeled as auxiliary light sources 13a, 13b and 13c.

The plurality of functions n of the electronic device N are respectively labeled as functions na, nb and nc, which represent different functions.

The touch icon module 1 of the present invention includes a controller C and a function instruction table 40. The function instruction table 40 contains a plurality of function instructions 41, i.e., the function instruction 41a, the function instruction 41b and the function instructions 41c. The controller C is installed in the touch plate 10. The function instruction table 40 and the plurality of function instructions 41 are stored in the controller C. The plurality of function instructions 41 in the function instruction table 40 correspond to the plural functions n of the electronic device N. In addition, the function instruction 41a corresponds to the function na, the function instruction 41b corresponds to the function nb, and the function instruction 41c corresponds to a function nc.

In the touch plate 10, the main area 111 in the operation area 11 corresponds to the function instruction table 40, and the plurality of auxiliary areas 112 in the operation area 11 correspond to the plurality of function instructions 41. For example, the auxiliary area 112a corresponds to the function instruction 41a, the auxiliary area 112b corresponds to the function instruction 41b, and the auxiliary area 112c corresponds to the function instruction 41c.

Please also refer to FIG. 1. The main light source 12 corresponds to the main icon 20 and the main area 111. The auxiliary light source 13a corresponds to the auxiliary icon 30a and the auxiliary area 112a. The auxiliary light source 13b corresponds to the auxiliary icon 30b and the auxiliary area 112b. The auxiliary light source 13c corresponds to the auxiliary icon 30c and the auxiliary area 112c.

In an implementation example, a plurality of network connection functions n for the electronic device N include an airplane mode function na, a wireless network connection function nb and a Bluetooth wireless connection function nc. The auxiliary icon 30a with the airplane mode pattern corresponds to the auxiliary area 112a and the auxiliary light source 13a. In response to the function instruction 41a, the airplane mode function na of the electronic device N is correspondingly controlled. In this implementation example, the airplane mode pattern of the auxiliary icon 30a is the well-known airplane mode pattern. The airplane mode pattern is related to an airplane mode. In the airplane mode, the function of receiving and transmitting network connection signals is disabled, and thus the flight of is not affected. The auxiliary icon 30a is displayed on the touch plate 10 for switching to the airplane mode in the quick access manner. The operations of the other auxiliary icons 30, the other auxiliary areas 112, the other auxiliary light sources 13 and the other function instructions 41 are similar to those mentioned above.

As shown in FIG. 5A, the touch icon module 1 is in the general status mode. Under this circumstance, the touch plate 10 provides the ordinary touching and sliding pointer function similar to the general touch pad. Meanwhile, the main light source 12 continuously illuminates the main icon 20, and the main icon 20 is continuously displayed on the touch plate 10. The presence of the main icon 20 allows the user to identify and determine whether to switch the touch icon module 1 to the shortcut function trigger mode.

Please refer to FIG. 5B and FIG. 4. After the main icon 20 on the touch plate 10 is touched, the operation mode of the touch icon module 1 is switched to the shortcut function trigger mode. Furthermore, when the main icon 20 is touched, the main area 111 generates a first touch signal 1111. After the controller C receives the first touch signal 1111, the controller C generates an auxiliary light source control signal 131. In response to the auxiliary light source control signal 131, the plurality of auxiliary light sources 13 are turned on to illuminate the plurality of auxiliary icons 30, and the plurality of auxiliary icons 30 are displayed on the plurality of auxiliary areas 112. Furthermore, after the controller C receives the first touch signal 1111 from the main area 111, the function instruction table 40 is controlled and activated. Preferably, the controller C generates a main light source control signal 121 according to the first touch signal 1111. According to the main light source control signal 121, the intensity or color of the light beam from the main light source 12 is correspondingly changed. Consequently, the main icon 20 is subjected to a change to prompt the user whether the operation mode is switched successfully.

Please refer to FIG. 5C and FIG. 4. When the auxiliary icon 30a of the plurality of auxiliary icons 30 is touched, the corresponding auxiliary area 112a generates a second touch signal 1121. After the controller C receives the second touch signal 1121, the function instruction 41a corresponding to the auxiliary area 112a in the function instruction table 40 is controlled and activated. According to the function instruction 41a, a function control signal 401 is generated to control the corresponding function na of the electronic device N. Furthermore, when the controller C receives the second touch signal 1121 from the auxiliary area 112a, the auxiliary light source control signal 131 is generated. The auxiliary light source control signal 131 is transmitted to the corresponding auxiliary light source 13a. According to the auxiliary light source control signal 131, the intensity or color of the light beam from the auxiliary light source 13a is correspondingly changed. Consequently, the auxiliary icon 30 is subjected to a change to prompt the user whether the corresponding function na of the electronic device N is activated or controlled successfully.

In other words, while the main icon 20 is continuously displayed, the on/off statuses of the auxiliary icons 30 can be selectively switched. Consequently, the purpose of triggering the auxiliary icons 30 in a quick access manner can be achieved.

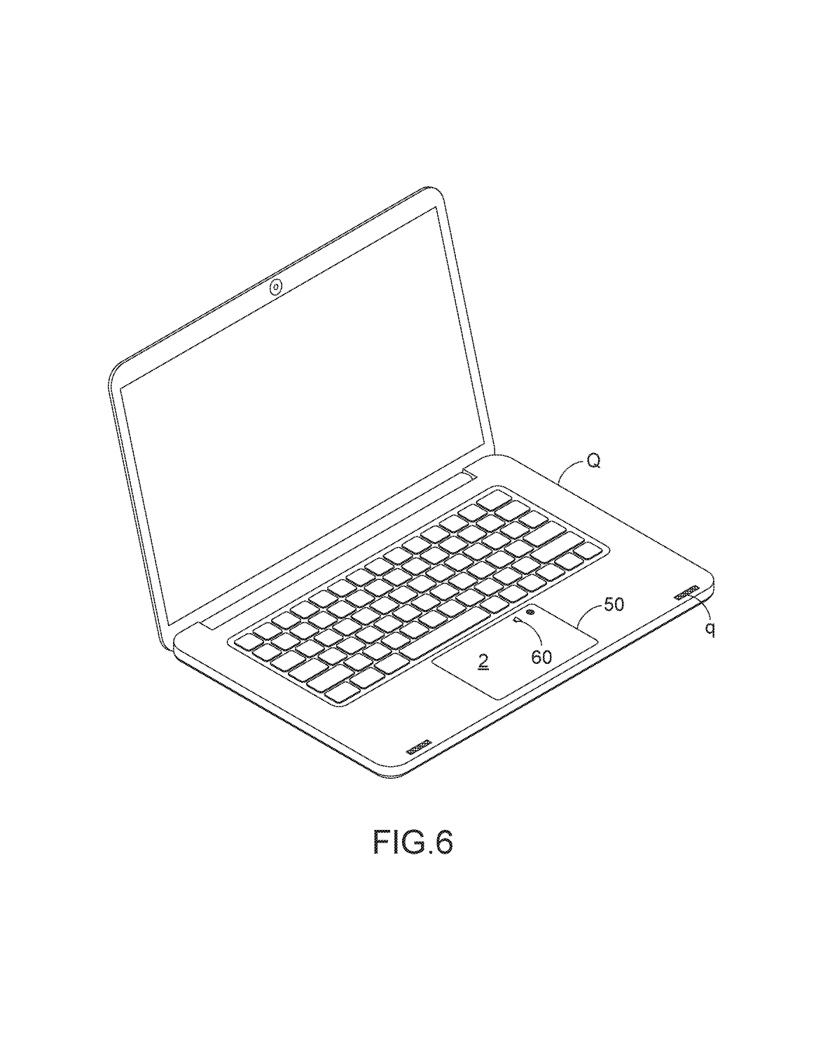

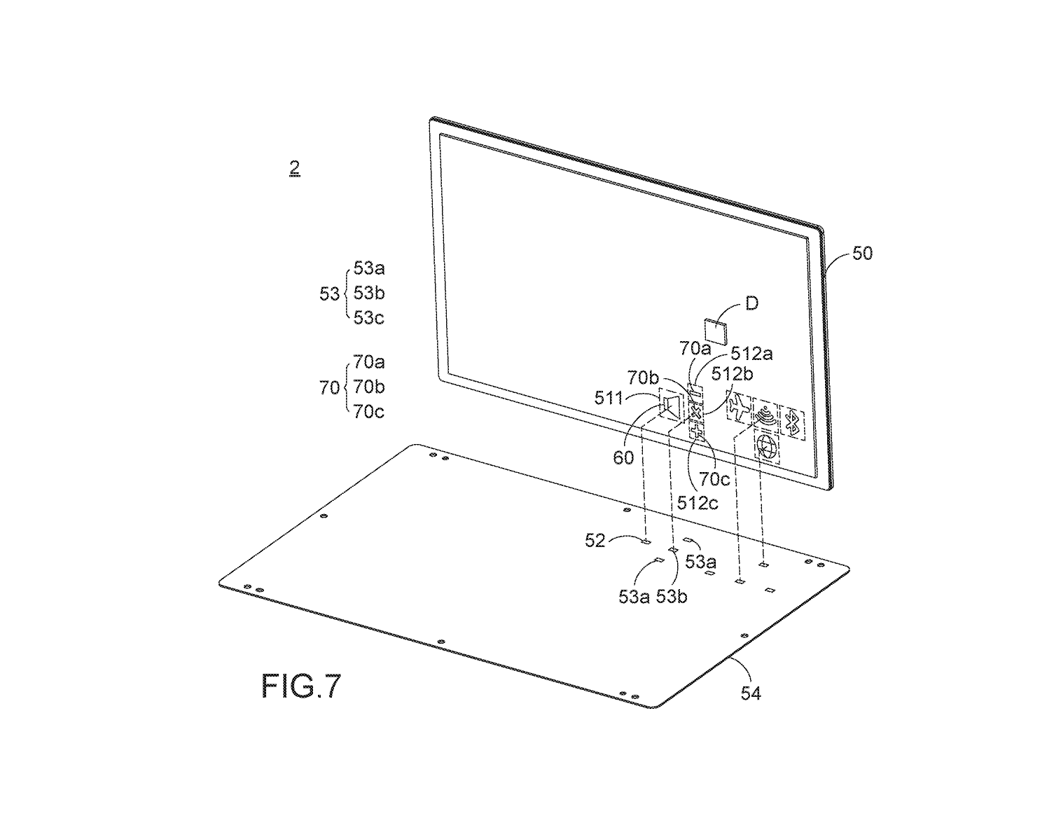

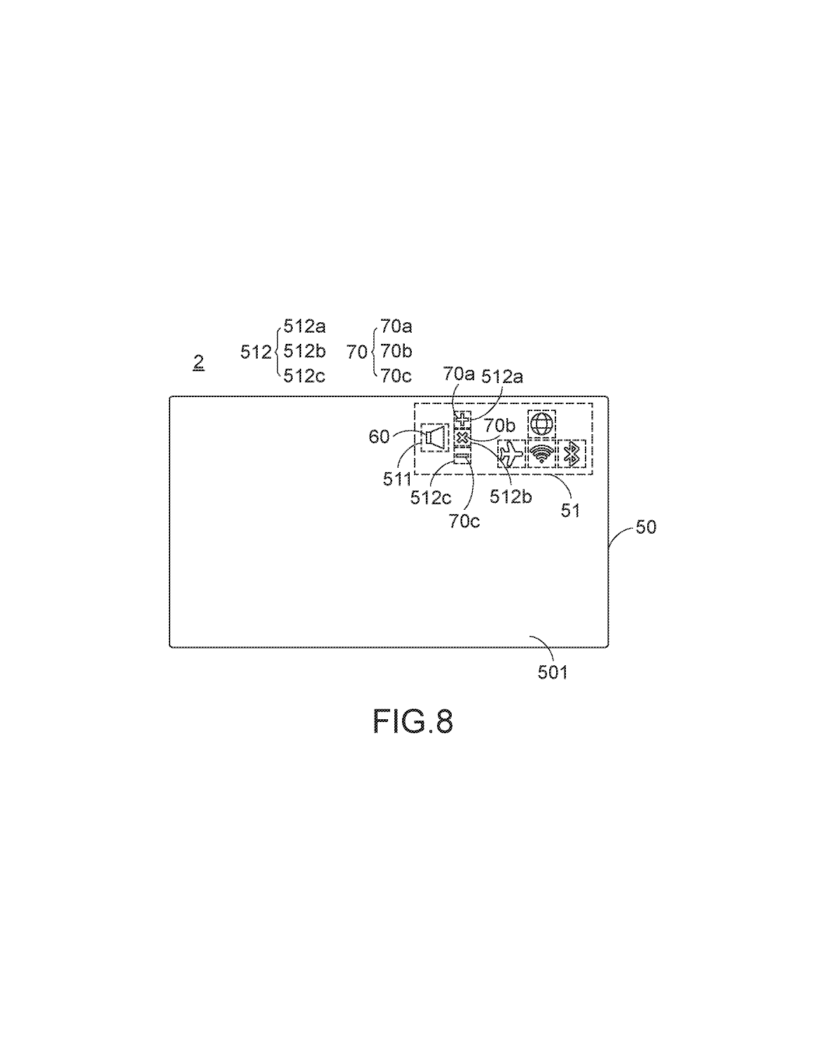

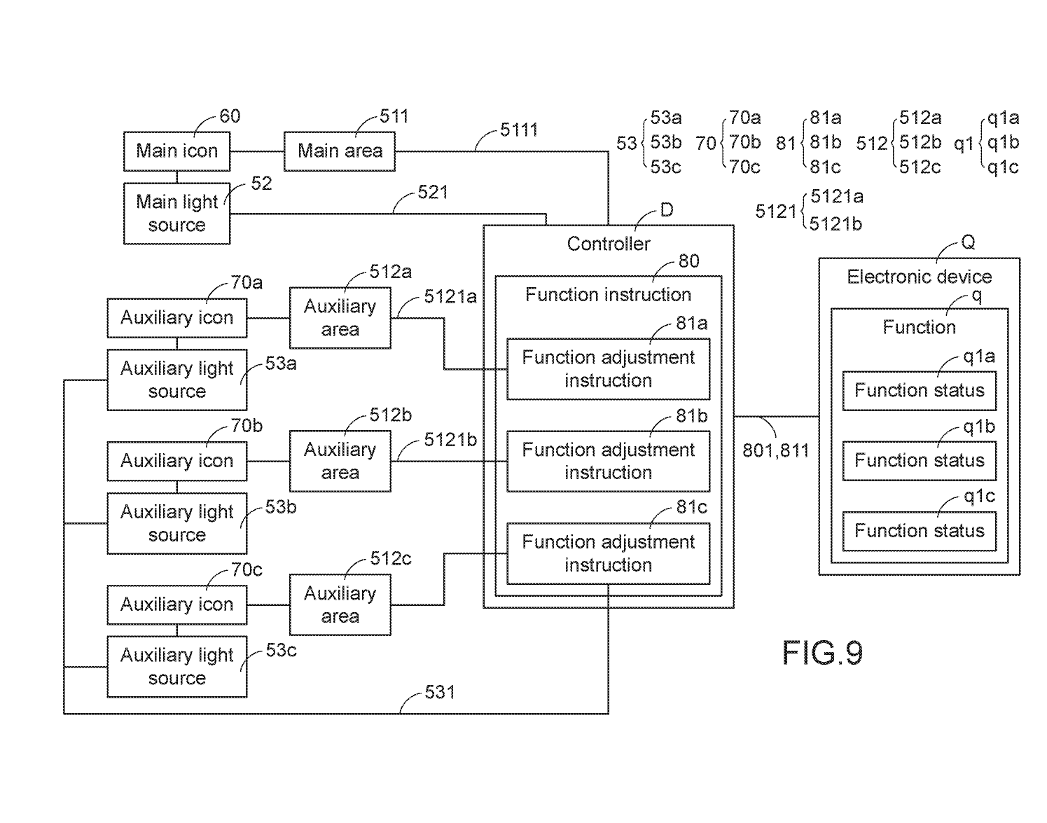

Another embodiment of the touch icon module is provided. FIG. 6 is a schematic perspective view illustrating a computing device with a touch icon module according to a second embodiment of the present invention. FIG. 7 is a schematic exploded view illustrating the touch icon module according to the second embodiment of the present invention. FIG. 8 is a planar view illustrating the touch icon module in a shortcut function trigger mode. FIG. 9 is a schematic functional block diagram illustrating a signal processing process of the touch icon module according to the second embodiment of the present invention.

The touch icon module 2 is electrically connected with an electronic device Q. The electronic device Q has a function q. The function q has a plurality of function statuses q1. The touch icon module 1 is used to control the function q of the electronic device Q and adjust the function statuses q1 of the function q.

In this embodiment, the touch icon module 2 includes a touch plate 50, a main icon 60, a plurality of auxiliary icons 70, a function instruction 80, a plurality of function adjustment instructions 81 and a controller D. The touch plate 50 is provided with a general touch area 501, an operation area 51, a main light source 52, a plurality of auxiliary light sources 53 and a circuit layer 54. The operation area 51 of the touch plate 50 includes a main area 511 and a plurality of auxiliary areas 512. The general touch area 501 and the operation area 51 are located beside each other. The general touch area 501 can provide the ordinary touching and sliding pointer function only.

The main icon 60 is used to prompt the activation status of the function q in the electronic device Q. The plurality of auxiliary icons 70 are used to prompt the function status q1 of the function q in the electronic device Q that can be adjusted. Preferably, the area occupied by a single auxiliary icon 70 is smaller than the area occupied by the main icon 60.

In the touch plate 50, the plurality of auxiliary areas 512 and the main area 511 of the operation area 51 are located beside each other. In addition, the plurality of auxiliary areas 512 are located near the edge of the main area 511.

The main icon 60 is included in the operation area 51. In addition, the main icon 60 corresponds to the main area 511. The plurality of auxiliary icons 70 are included in the operation area 51. In addition, the plurality of auxiliary icons 70 correspond to the plurality of auxiliary areas 512, respectively. That is, each auxiliary icon 70 corresponds to one of the auxiliary areas 512.

The main light source 52 and the plurality of auxiliary light sources 53 of the touch plate 50 are installed on the circuit layer 54. The main light source 52 corresponds to the main area 511 and the main icon 60. The plurality of auxiliary light sources 53 correspond to the plurality of auxiliary areas 512 and the plurality of auxiliary icons 70. Preferably, each auxiliary light source 53 corresponds to one of the auxiliary areas 512 and one of the auxiliary icons 70.

The controller D of the touch icon module 2 is installed in the circuit layer 54. The function instruction 80 and the plurality of function instructions 81 are stored in the controller D. The function instruction 80 corresponds to the function q of the electronic device Q. The plurality of function adjustment instructions 81 correspond to the plurality of function statuses q1 of the function q. In addition, each function adjustment instruction 81 corresponds to one function status q1. The main area 511 of the operation area 51 corresponds to the function instruction 80. The plurality of auxiliary areas 512 correspond to the plurality of function adjustment instructions 81. In addition, each auxiliary area 512 corresponds to one function adjustment instruction 81. When the main icon 60 is touched, the main area 511 generates a first touch signal 5111 to activate the function q of the electronic device Q. When one of the plurality of auxiliary icons 70 is touched, the auxiliary area 512 corresponding to the touched auxiliary icon 70 generates a second touch signal to adjust the function status q1 of the electronic device Q.

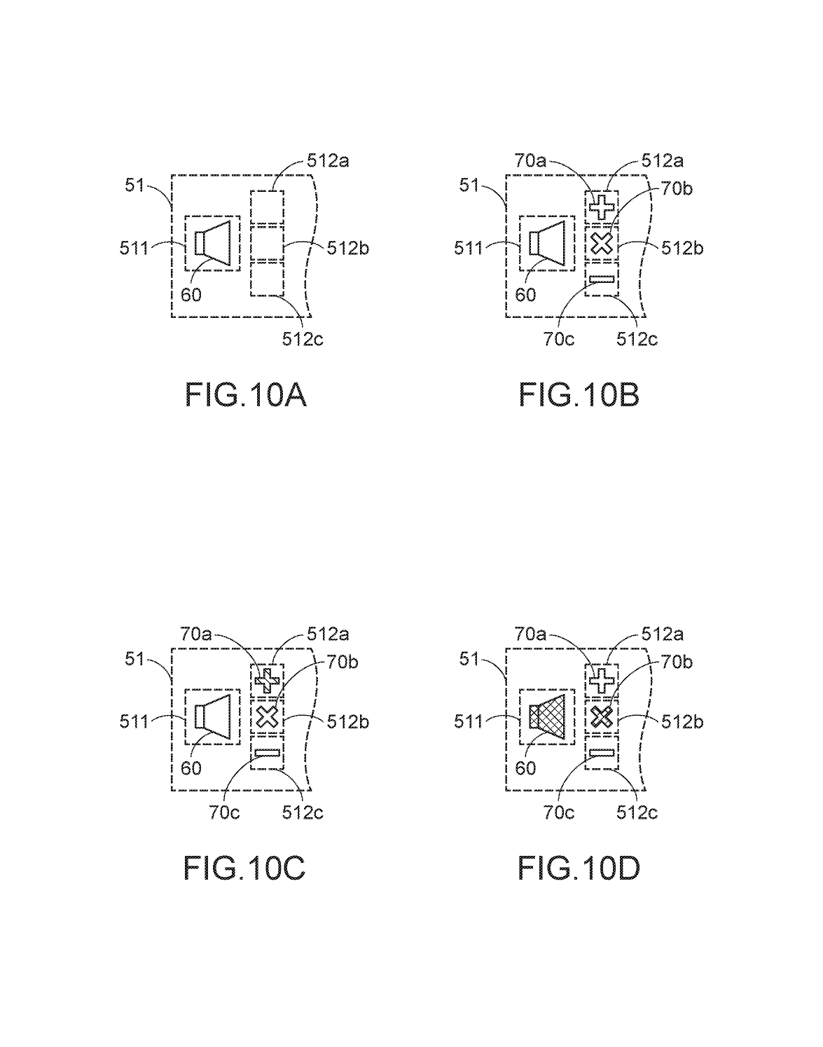

Hereinafter, the icon triggering mechanism and the control method for the touch icon module of the second embodiment will be illustrated with reference to FIG. 9, FIG. 10A, FIG. 10B, FIG. 10C and FIG. 10D. FIG. 9 is a schematic functional block diagram illustrating a signal processing process of the touch icon module according to the second embodiment of the present invention. FIG. 10A schematically illustrates the image shown on the touch plate of the touch icon module according to the first embodiment of the present invention when the touch icon module is in the general status mode. FIG. 10B schematically illustrates the image shown on the touch plate of the touch icon module according to the second embodiment of the present invention when a function of the electronic device is activated. FIG. 10C schematically illustrates the image shown on the touch plate of the touch icon module according to the second embodiment of the present invention when an auxiliary icon is touched. FIG. 10D schematically illustrates the image shown on the touch plate of the touch icon module according to the second embodiment of the present invention when another auxiliary icon is touched.

For illustration, a plurality of function adjustment instructions 81 are respectively labeled as function adjustment instructions 81a, 81b and 81c, the plurality of auxiliary areas 512 are respectively labeled as auxiliary areas 512a, 512b and 512c, the plurality of auxiliary icons 70 are respectively labeled as auxiliary icons 70a, 70b and 70c, and the plurality of auxiliary light sources 53 are respectively labeled as auxiliary light sources 53a, 53b and 53c.

The plurality of function statuses q1 of the function q of the electronic device Q are respectively labeled as function statuses q1a, q1b and q1c, which represent different function statuses.

In an implementation example, the function q is a sound playback function in the electronic device Q. The sound playback function q has a plurality function statuses q1 for allowing the user to adjust. For example, the function status q1a is a volume increase function status, the function state q1b is a mute function status, and the function status q1c is a volume reduction function status. The speaker pattern indicated by the main icon 60 is a known and recognized sound playback function pattern. The plus pattern, the cross pattern and the minus pattern indicated by the plurality of auxiliary icons 70 are also common patterns representing volume increase, mute and volume reduction. In this example, the sound playback function can be quickly controlled and adjusted on the touch plate 50 according to the combination of the main icon 60 and the plurality of auxiliary icons 70.

Please refer to FIG. 9 and FIG. 10A. When the main icon 60 is displayed on the main area 511 of the operation area 51, the user is prompted that the function q in the electronic device Q represented by the main icon 60 is in an inactive state, a standby stat, or an original setting status that has not been adjusted. Meanwhile, the plurality of auxiliary icons 70 are not displayed on the plurality of auxiliary areas 512, and the shortcut control and adjustment function cannot be triggered. Under this circumstance, the touch plate 10 provides the ordinary touching and sliding pointer function similar to the general touch pad.

Please refer to FIG. 9 and FIG. 10B. After the main icon 60 is touched, the function instruction 80 can be triggered, and the function q of the electronic device Q can be activated. Meanwhile, if the main icon 60 is touched again while the function instruction 80 and the function q of the electronic device Q are triggered and activated, the function instruction 80 can be inactivated and the function q of the electronic device Q can be inactivated.

For example, when the main icon 60 is touched, the main area 511 generates a first touch signal 5111 to the controller D. After the controller D receives the first touch signal 5111, the controller D activates the function instruction 80 and generates a first function control signal 801 to the electronic device Q. Consequently, the function q of the electronic device Q is activated. Furthermore, after the controller D receives the first touch signal 5111, the controller D generates a main light source control signal 521 and an auxiliary light source control signal 531. In response to the auxiliary light source control signal 531, the plurality of auxiliary light sources 53 are turned on to illuminate the plurality of auxiliary icons 70. At the same time, the plurality of auxiliary icons 70 are displayed on the plurality of auxiliary areas 512 to prompt the user that all statuses of the function q of the electronic device Q can be adjusted. According to the main light source control signal 521, the main icon 60 is continuously illuminated by the main light source 52. In addition, the intensity or color of the light beam from the main light source 52 is correspondingly changed to prompt the user whether the function q of the electronic device Q is activated or not.

Please refer to FIG. 9 and FIG. 10C. The auxiliary areas 512 corresponding to the plurality of auxiliary icons 70 generate second touch signals 5121. For example, when the auxiliary icon 70a of the plurality of auxiliary icons 70 is touched, the auxiliary area 512a corresponding to the auxiliary icon 70a generates a second touch signal 5121a. After the controller D receives the second touch signal 5121a, the function adjustment instruction 81a corresponding to the auxiliary area 512a is triggered. In addition, the controller D generates a function adjustment signal 811 to the electronic device Q. According to the function adjustment instruction 81a, the function status q1a of the function q of the electronic device Q is correspondingly adjusted. Furthermore, according to the second touch signal 5121 from the plurality of auxiliary areas 512, the plurality of auxiliary light sources 53 are controlled to illuminate the plurality of auxiliary icons 70. In this embodiment, after receiving the second touch signal 5121a, the controller D generates the auxiliary light source control signal 531 to controls the change of the light intensity or color of the auxiliary light source 53a. Consequently, the auxiliary icon 70a generates a light color change for facilitating the user’s identification.

In the above example, the function q is the sound playback function in the electronic device Q. When the plus pattern displayed on the auxiliary icon 70a is touched, the controller D generates a function adjustment signal 811 to the electronic device Q to adjust the sound playback function q. According to the function adjustment signal 811, the sound playback function q is in the volume increase function status q1a. Meanwhile, the color of the plus pattern displayed on the auxiliary icon 70a is changed to prompt the user.

Please refer to FIG. 9 and FIG. 10D. The plurality of function adjustment instructions 81 corresponding to the plurality of auxiliary icons 70 can also be configured to have the effect of switching the main icon 60.

For example, in FIG. 10D, the auxiliary icon 70b and the auxiliary light source 53b corresponding to the auxiliary area 512b and the function adjustment instruction 81b will be taken an example for illustration.

When the auxiliary icon 70b is touched, the auxiliary area 512b corresponding to the auxiliary icon 70b generates a second touch signal 5121b. After the controller D receives the second touch signal 5121b, the function adjustment instruction 81b corresponding to the auxiliary area 512b is triggered. In addition, the controller D generates a function adjustment signal 811 to the electronic device Q according to the function adjustment instruction 81b. Consequently, the function status q1b of the function q of the electronic device Q is correspondingly adjusted. Furthermore, after the controller D receives the second touch signal 5121b, the controller D generates the auxiliary light source control signal 531 and the main light source control signal 521. According to the auxiliary light source control signal 531, the intensity or color of the light beam from the auxiliary light source 53b to illuminate the auxiliary icon 70b is changed. Consequently, the auxiliary icon 70b generates a light color change. According to the main light source control signal 521, the intensity or color of the light beam from the main light source 52 is changed. Consequently, the main icon 60 generates a light color change for facilitating the user’s identification.

In the above example, the function q is the sound playback function in the electronic device Q. When the cross pattern displayed on the auxiliary icon 70b is touched, the controller D generates a function adjustment signal 811 to the electronic device Q to adjust the sound playback function q. According to the function adjustment signal 811, the sound playback function q is in the mute function status q1b. Meanwhile, the cross pattern displayed on the auxiliary icon 70b and the main icon 50 are changed to the same color to prompt the user. However, the auxiliary icons 70a and 70c are maintained in their original statuses.

In other words, while the main icon 60 is continuously displayed, the on/off statuses of the auxiliary icons 70 are selectively switched. Consequently, the purpose of triggering the auxiliary icons 70 in the quick access manner can be achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A touch icon module electrically connected with an electronic device to control the electronic device, the touch icon module comprising:
a touch plate with an operation area, wherein the operation area has a main area and a plurality of auxiliary areas, and the plurality of auxiliary areas are located beside an edge of the main area;
a main icon included in the operation area, wherein the main icon corresponds to the main area; and
a plurality of auxiliary icons included in the operation area, wherein the plurality of auxiliary icons correspond to the plurality of auxiliary areas, and each auxiliary icon corresponds to one of the plurality of auxiliary areas,
wherein after the main icon is touched, the main area generates a first touch signal to control the plurality of auxiliary icons to be displayed in the plurality of auxiliary areas, wherein after one of the auxiliary icons is touched, one of the auxiliary areas corresponding to the touched auxiliary icon generates a second touch signal to control the electronic device.

2. The touch icon module according to claim 1, wherein the plurality of auxiliary areas and the main area are located beside each other, the plurality of auxiliary icons are located beside the main icon, and the plurality auxiliary icons are located beside each other.

3. The touch icon module according to claim 1, wherein the main icon prompts activation statuses of the plurality of auxiliary icons, and the plurality of auxiliary icons prompt a function control status of the electronic device.

4. The touch icon module according to claim 1, wherein the touch icon module further comprises a function instruction table, and the function instruction table contains a plurality of function instructions corresponding to a plurality of functions of the electronic device, wherein each of the function instructions corresponds to one of the plurality of functions.

5. The touch icon module according to claim 1, wherein the main area of the operation area corresponds to the function instruction table, the plurality of auxiliary areas of the operation area correspond to the plurality of function instructions, and each of the auxiliary areas corresponds to one of the plurality of function instructions.

6. The touch icon module according to claim 5, wherein after the main icon is touched, the main area generates the first touch signal to control the function instruction table, and the plurality of auxiliary icons are displayed in the plurality of auxiliary areas according to the first touch signal.

7. The touch icon module according to claim 5, wherein after one of the plurality of auxiliary icons is touched, the auxiliary area corresponding to the touched auxiliary icon generates a second touch signal, the function instruction corresponding to the auxiliary area is controlled according to the second touch signal, and the corresponding function of the electronic device is controlled according to the function instruction.

8. The touch icon module according to claim 1, wherein the touch plate comprises a main light source and a plurality of auxiliary light sources, wherein the main light source corresponds to the main area and the main icon, and the plurality of auxiliary light sources correspond to the plurality of auxiliary areas and the plurality of auxiliary icons.

9. The touch icon module according to claim 8, wherein the main icon is continuously illuminated by the main light source, so that the main icon is continuously displayed on the touch plate, wherein when the main icon is touched and the main area generates the first touch signal, the plurality of auxiliary light sources are controlled to illuminate the plurality of auxiliary icons according to the first touch signal, so that the plurality of auxiliary icons are displayed in the plurality of auxiliary areas.

10. The touch icon module according to claim 9, wherein when one of the plurality of auxiliary icons is touched and the corresponding auxiliary area generates the second touch signal, the plurality of auxiliary light sources are controlled according to the second touch signal.

11. A touch icon module electrically connected with an electronic device to control a function of the electronic device, the touch icon module comprising:
a touch plate with an operation area, wherein the operation area has a main area and a plurality of auxiliary areas, and the plurality of auxiliary areas are adjacent to the main area and located beside an edge of the main area;
a main icon included in the operation area, wherein the main icon corresponds to the main area; and
a plurality of auxiliary icons included in the operation area, wherein the plurality of auxiliary icons correspond to the plurality of auxiliary areas, and each auxiliary icon corresponds to one of the plurality of auxiliary areas,
wherein after the main icon is touched, the main area generates a first touch signal to activate the function of the electronic device, wherein after one of the auxiliary icons is touched, one of the auxiliary areas corresponding to the touched auxiliary icon generates a second touch signal to adjust the function of the electronic device.

12. The touch icon module according to claim 11, wherein the main icon prompts an activation status of the function, and the plurality of auxiliary icons prompt an adjustment status of the function of the electronic device, wherein an area of each of the plurality of auxiliary icons is smaller than an area of the main icon.

13. The touch icon module according to claim 11, wherein the touch icon module further provides a function instruction and a plurality of function adjustment instructions, and the function of the electronic device has a plurality of function statuses, wherein the function instruction corresponds to the function of the electronic device, the plurality of function adjustment instructions correspond to the plurality of function statuses of the function, and each of the function adjustment instructions corresponds to one of the plurality of function statuses.

14. The touch icon module according to claim 13, wherein the main area of the operation area corresponds to the function instruction, the plurality of auxiliary areas correspond to the plurality of function adjustment instructions, and each of the auxiliary areas corresponds to one of the plurality of function adjustment instructions.

15. The touch icon module according to claim 14, wherein after the main icon is touched, the main area generates the first touch signal to trigger the function instruction of the electronic device and activate or inactivate the function of the electronic device.

16. The touch icon module according to claim 14, wherein after one of the plurality of auxiliary icons is touched, the auxiliary area corresponding to the touched auxiliary icon generates the second touch signal to trigger the function adjustment instruction corresponding to the auxiliary area, wherein the corresponding function status of the electronic device is adjusted according to the function adjustment instruction.

17. The touch icon module according to claim 11, wherein the touch plate comprises a main light source and a plurality of auxiliary light sources, wherein the main light source corresponds to the main area and the main icon, the plurality of auxiliary light sources correspond to the plurality of auxiliary areas and the plurality of auxiliary icons, and each of the auxiliary light sources corresponds to one of the plurality of auxiliary areas and one of the plurality of auxiliary icons.

18. The touch icon module according to claim 17, wherein when the main area generates the first touch signal, the main light source is controlled to illuminate the main icon, and the plurality of auxiliary light sources are controlled to illuminate the plurality of auxiliary icons, wherein when the plurality of auxiliary areas generate the second control signal, the plurality of auxiliary light sources are controlled to illuminate the plurality of auxiliary icons according to the second touch signal, and the main light source is controlled to illuminate the main icon according to the second touch signal.
